(19) United States
(12) Patent Application Publication
(10) Pub. No.: US 2026/0322288 A1
(43) Pub. Date: Oct. 15, 2026

(54) POWER CONVERTER AND METHOD OF CONTROLLING POWER CONVERTER

(71) Applicants: Mitsubishi Electric Corporation, TOKYO (JP); TMEIC Corporation, Tokyo (JP)

(72) Inventors: Hiroki ISHIHARA, Chiyoda-ku, Tokyo (JP); Takushi JIMICHI, Chiyoda-ku, Tokyo (JP); Toshiaki OKA, Chuo-ku, Tokyo (JP); Kazuhide KANEKO, Chuo-ku, Tokyo (JP); Takumi ITO, Chuo-ku, Tokyo (JP)

(73) Assignees: Mitsubishi Electric Corporation, TOKYO (JP); TMEIC Corporation, TOKYO (JP)

(21) Appl. No.: 19/489,926

(22) PCT Filed: Jun. 8, 2023
(86) PCT No.: PCT/JP2023/021394

§ 371 Date: Dec. 4, 2025

(51) Int. Cl. H02M 7/219; H02M 1/084; H02M 1/32; H02M 7/217

(52) U.S. Cl. CPC H02M 7/219; H02M 1/084; H02M 1/32; H02M 7/2173

(57) ABSTRACT

A power converter includes an arm portion and a controller to control the arm portion. The arm portion includes a plurality of cells connected in series. The controller: switches, in correspondence with each of the plurality of cells, states of the plurality of semiconductor switch elements to any one of states including a state in which the pair of connection terminals output at least one voltage of a positive voltage and a negative voltage and a state in which the pair of connection terminals are conducting; selects, for each predetermined timing, one cell of the plurality of cells, a state of the one cell being switched based on the voltage of the power storage element of each of the plurality of cells and duration of the states of the plurality of cells; and switches the states of the plurality of semiconductor switch elements included in the selected cell.

### TECHNICAL FIELD

The present disclosure relates to a power converter interconnected to a power system.

### BACKGROUND ART

A power converter is interconnected to a power system for adjusting a voltage, adjusting a power factor, and improving stability in the power system. The power converter contributes to stabilization of frequency and voltage of the power system by controlling a plurality of semiconductor switches and inputting and outputting active power and reactive power to and from the power system.

The power converters come in various configurations, and particularly, in recent years, there has been an increase in cases where a power converter including a plurality of configuration units, which are referred to as cells, are connected to each other.

Control of such a power converter with the plurality of cells requires not only control that directly contributes to the system but also equalization of capacitor voltages of the cells, and requires the following selection at each interval. For example, from which cell capacitor discharging of electric power is performed, to which cell capacitor charging of electric power is performed, or neither of the above is performed. The commands for cell selection and operation are provided to the semiconductor switches of the cells, and an operation according to an output of control is performed by switching between ON and OFF states. (See PTL 1)

### CITATION LIST

### Patent Literature

PTL 1: Japanese Patent Laying-Open No. 2022-99845

### SUMMARY OF INVENTION

### Technical Problem

When the semiconductor switch of the cell is switched to the ON state and then switched back to the OFF state in a very short period of time, due to its electrical characteristics, a serge may occur or the semiconductor switch may break down. In the configuration of PTL 1, the period of time from the cell entering the ON state to the cell entering the OFF state is not guaranteed, and the switching state of the same cell may be switched in a very short period of time. In other words, the occurrence of a surge or breakdown cannot be prevented in the semiconductor switch.

The present disclosure has been made to solve the problem described above. An object of the present disclosure is to provide a power converter and a method of controlling the same that can prevent the occurrence of a surge or breakdown.

### Solution to Problem

A power converter according to an embodiment includes an arm portion and a controller to control the arm portion. The arm portion includes a plurality of cells connected in series. Each of the plurality of cells includes a pair of connection terminals, a plurality of semiconductor switch elements, a power storage element connected in parallel to the plurality of semiconductor switch elements, and a voltage detector to detect a voltage of the power storage element. The controller: switches, in correspondence with each of the plurality of cells, states of the plurality of semiconductor switch elements included in a corresponding cell to any one of states including a state in which the pair of connection terminals of the corresponding cell output at least one voltage of a positive voltage and a negative voltage and a state in which the pair of connection terminals are conducting; selects, for each predetermined timing, one cell of the plurality of cells, a state of the one cell being switched based on the voltage of the power storage element of each of the plurality of cells and duration of the states of the plurality of cells; and switches the states of the plurality of semiconductor switch elements included in the selected cell.

A method of controlling a power converter according to an embodiment is a method of controlling a power converter including an arm portion. The arm portion includes a plurality of cells connected in series. The plurality of cells include a pair of connection terminals, a plurality of semiconductor switch elements, a power storage element connected in parallel to the plurality of semiconductor switch elements, and a voltage detector to detect a voltage of the power storage element. The method includes: selecting one cell of the plurality of cells for each predetermined timing, a state of the one cell being switched based on the voltage of the power storage element of each of the plurality of cells and duration of states of the plurality of cells; and switching the states of the plurality of semiconductor switch elements included in the selected cell to any one of states including a state in which the pair of connection terminals of the selected cell output at least one voltage of a positive voltage and a negative voltage and a state in which the pair of connection terminals are conducting.

### Advantageous Effects of Invention

The power converter and the method of controlling the same according to the present disclosure can prevent the occurrence of a surge or breakdown.

### BRIEF DESCRIPTION OF DRAWINGS

FIG. 1 is a diagram illustrating a configuration of a power converter 1 according to Embodiment 1.

FIG. 2 is a diagram illustrating a configuration of a cell 10 according to Embodiment 1.

FIG. 3 is a diagram illustrating a function of a control circuit 50 according to Embodiment 1.

FIG. 4 is a diagram illustrating a state of cell 10 according to Embodiment 1.

FIG. 5 is a diagram illustrating combinations of conduction states of semiconductor switch elements Q1 to Q4 according to Embodiment 1.

FIG. 6 is a diagram illustrating the timing at which the state of cell 10 is switched according to Embodiment 1.

FIG. 7 is a diagram illustrating states of cells 10A and 10B according to a comparative example.

FIG. 8 is a diagram illustrating states of cells 10A and 10B according to Embodiment 1.

FIG. 9 is a flowchart illustrating a cell selection process by control circuit 50 according to Embodiment 1.

FIG. 10 is a diagram illustrating a function of a control circuit 51 according to Embodiment 2.

FIG. 11 is a diagram illustrating a cell switching procedure.

FIG. 12 is a flowchart illustrating a cell selection process by control circuit 50 according to Embodiment 2.

FIG. 13 is a flowchart illustrating cell classification according to Embodiment 2.

FIG. 14 is a flowchart illustrating cell classification according to Embodiment 3.

FIG. 15 is a diagram illustrating capacitor voltages of cells according to a comparative example and Embodiment 3.

### DESCRIPTION OF EMBODIMENTS

### Embodiment 1

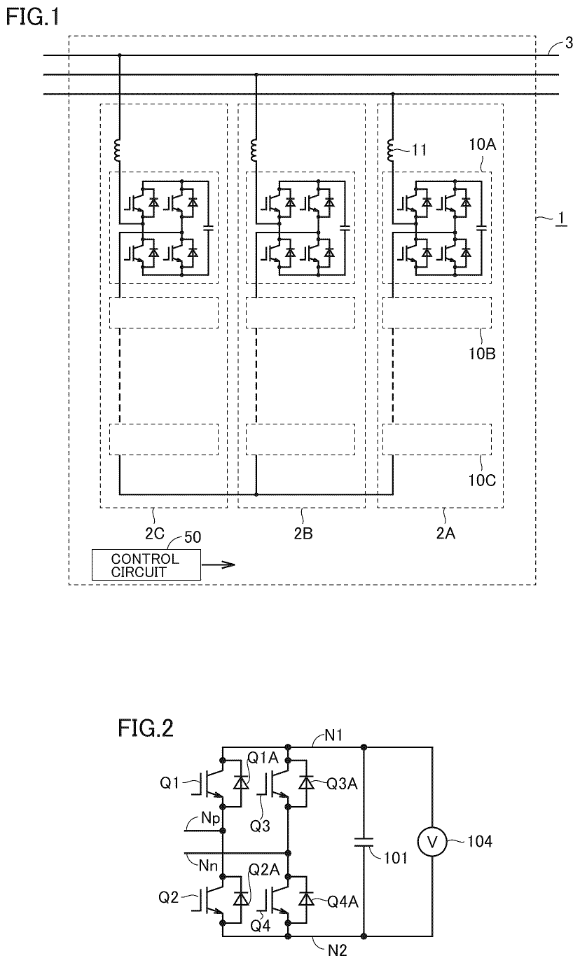

FIG. 1 is a diagram illustrating a configuration of a power converter 1 according to Embodiment 1.

Referring to FIG. 1, an example of power converter 1 according to Embodiment 1 includes arm portions 2A to 2C (also collectively referred to as an arm portion 2 below) for three respective phases of a power transmission line 3, and a control circuit 50 that controls arm portions 2A to 2C. The configuration of arm portion 2 is the same among the respective phases, and accordingly, detailed description thereof will not be repeated. In this example, the configuration of arm portion 2A will be described by way of example. Additionally, the case where control circuit 50 controls arm portion 2A will be described by way of example.

Arm portion 2A includes a plurality of cells 10A to 10C (also collectively referred to as a cell 10 below) and an interconnection reactor 11.

The plurality of cells 10A to 10C are connected in series to each other and connected to interconnection reactor 11.

Each cell 10 has the same configuration.

FIG. 2 is a diagram illustrating a configuration of cell 10 according to Embodiment 1.

Referring to FIG. 2, cell 10 includes a plurality of semiconductor switch elements Q1 to Q4, diodes Q1A to Q4A respectively connected in anti-parallel to the plurality of semiconductor switch elements Q1 to Q4, a capacitor 101 that is a power storage element, and a voltage detector 104 that detects a voltage of capacitor 101.

Semiconductor switch element Q1 and semiconductor switch element Q2 are connected in series between a node N1 and a node N2. Semiconductor switch element Q3 and semiconductor switch element Q4 are connected in series between node N1 and node N2. Semiconductor switch elements Q1 and Q2, semiconductor switch elements Q3 and Q4, and capacitor 101 are connected in parallel to one another between node N1 and node N2. Voltage detector 104 that detects a voltage of capacitor 101 is connected between node N1 and node N2.

A node Np, which is the connection node between semiconductor switch element Q1 and semiconductor switch element Q2, is connected to a node Nn of any other upstream cell 10 connected in series.

Node Nn, which is the connection node between semiconductor switch element Q3 and semiconductor switch element Q4, is connected to node Np of any other downstream cell 10 connected in series.

Node Np of the most upstream cell 10 is connected to interconnection reactor 11.

This configuration may also be referred to as a modular multilevel converter (MMC) and requires balance control to equalize the voltages of capacitors in each cell, in addition to control for exchanging electric power with a power system.

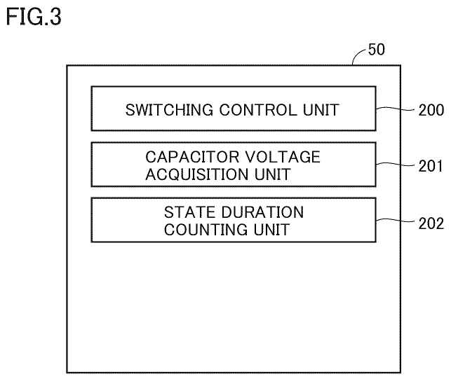

FIG. 3 is a diagram illustrating a function of control circuit 50 according to Embodiment 1.

Referring to FIG. 3, control circuit 50 includes a switching control unit 200 that controls ON/OFF of semiconductor switch elements Q1 to Q4 of cells 10A to 10C, a capacitor voltage acquisition unit 201 that obtains the capacitor voltages of cells 10A to 10C, and a state duration counting unit 202 that counts the duration of the respective states of cells 10A to 10C.

Capacitor voltage acquisition unit 201 obtains the voltage value of capacitor 101 from voltage detector 104 provided in each cell 10.

State duration counting unit 202 counts, when the respective states of cells 10A to 10C have changed, a period of time for which the changed states are maintained.

Switching control unit 200 controls ON/OFF of semiconductor switch elements Q1 to Q4 of cells 10A to 10C at predetermined timing, which will be described below.

Specifically, switching control unit 200 performs PWM control to control ON/OFF of semiconductor switch elements Q1 to Q4 of cells 10A to 10C based on the capacitor voltages of cells 10A to 10C obtained by capacitor voltage acquisition unit 201, the duration of the states of cells 10A to 10C in state duration counting unit 202, and the magnitude relationship between a command value and a carrier.

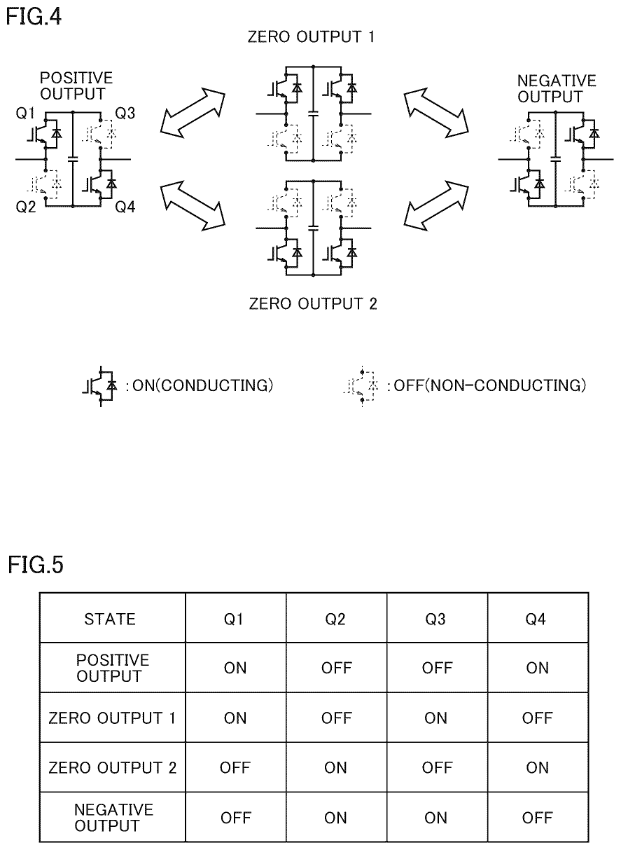

FIG. 4 is a diagram illustrating a state of cell 10 according to Embodiment 1.

FIG. 5 is a diagram illustrating combinations of conduction states of semiconductor switch elements Q1 to Q4 according to Embodiment 1.

Referring to FIGS. 4 and 5, when semiconductor switch elements Q1 and Q4 are ON (conducting) and semiconductor switch elements Q2 and Q3 are OFF (non-conducting), cell 10 enters a positive output state in which a positive voltage of capacitor 101 is applied to the output terminal of the cell.

Further, when semiconductor switch elements Q1 and Q3 are ON (conducting) and semiconductor switch elements Q2 and Q4 are OFF (non-conducting), cell 10 enters a zero output state (state 1) in which cell 10 outputs a zero voltage.

Further, when semiconductor switch elements Q2 and Q4 are ON (conducting) and semiconductor switch elements Q1 and Q3 are OFF (non-conducting), cell 10 enters a zero output state (state 2) in which cell 10 outputs a zero voltage.

Further, when semiconductor switch elements Q2 and Q3 are ON (conducting) and semiconductor switch elements Q1 and Q4 are OFF (non-conducting), cell 10 enters a negative output state in which cell 10 applies a negative voltage.

As shown in FIG. 4, by switching semiconductor switch elements Q1 to Q4 between ON and OFF according to FIG. 5, the positive output state, the negative output state, and the zero output state in which a zero voltage is output can be sequentially switched.

As shown in FIG. 4, there are two types of zero output states in which a zero voltage is output. “Zero output state” described merely in the following description may refer to either of the two types of states.

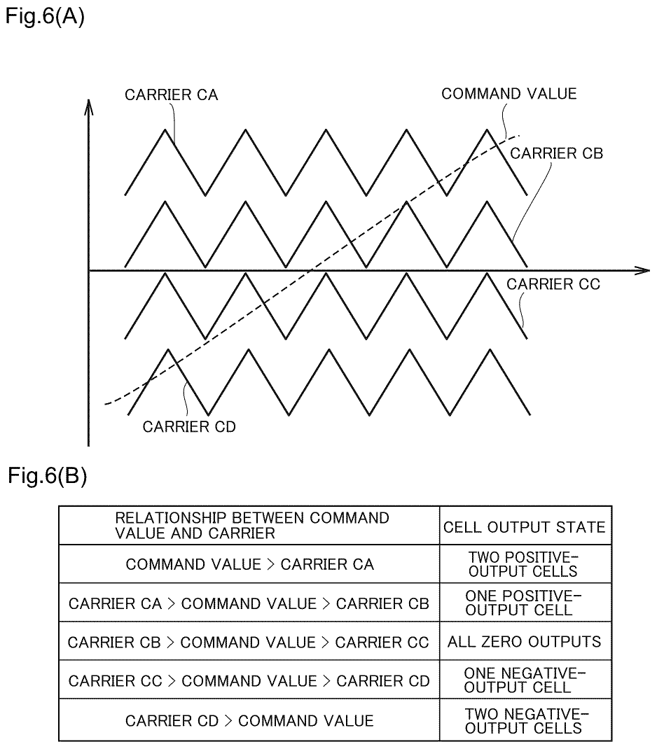

FIG. 6 is a diagram illustrating the timing at which the state of cell 10 is switched according to Embodiment 1.

Referring to FIG. 6, the case where level-shift PWM control is applied will be described.

Specifically, referring to FIG. 6(A), switching control unit 200 performs PWM control based on the magnitude relationship between a command value and a carrier. Specifically, the timing at which the state of cell 10 is switched is determined based on the magnitude relationship between a plurality of triangular wave carriers and a command value, as indicated by the horizontal axis representing a time and the vertical axis representing a voltage or a dimensionless quantity. In other words, switching control unit 200 determines whether to switch cell 10 to the positive output state by the number of times the command value, which is calculated based on the output current or capacitor voltage, has exceeded the carrier value when the command value is positive. Further, switching control unit 200 determines whether to switch cell 10 to the negative output state by the number of times the command value has fallen below the carrier value when the command value is negative. Subsequently, which cell 10 is brought to the output state or the zero output state is determined based on the capacitor voltage, whether the command value is positive or negative, and the direction of the current. In this example, among carriers CA to CD, carriers CA, CB are provided on the positive side, and carriers CC, CD are provided on the negative side. Carriers CA, CB are always in the range of zero or above, and carriers CC, CD are always in the range of zero or below.

The waveforms of carriers CA to CD in this example are merely examples and may be other waveforms. Further, centered on the zero line, carriers CC, CD may have waveforms that are line-symmetric with those of carriers CA, CB.

Referring to FIG. 6(B), the cell output state based on the relationship between a command value and a carrier will be described.

When the command value is greater than carrier CA, two cells in the positive output state are selected from among cells 10A to 10C. When the command value is between carrier CA and carrier CB, one cell in the positive output state is selected from among cells 10A to 10C. When the command value is between carrier CB and carrier CC, all cells 10A to 10C are set to the zero state. When the command value is between carrier CC and carrier CD, one cell in the negative output state is selected from among cells 10A to 10C. When the command value is smaller than carrier CD, two cells in the negative output state are selected from among cells 10A to 10C.

In order to make the voltages of capacitors 101 of the respective cells 10 as equal as possible, in one method, a cell whose state is to be switched is selected according to the magnitude of the voltage of capacitor 101.

This method may also be referred to as a sorting method.

For example, when switching cells 10 from the zero output state to the positive output state, if a current is flowing such that capacitor 101 is discharged, switching control unit 200 switches the plurality of cells 10 to the positive output state sequentially from cell 10 having the highest capacitor voltage, resulting in well-balanced capacitor voltages across cells 10.

When switching cells 10 from the zero output state to the positive output state, if a current is flowing such that capacitor 101 is charged, switching control unit 200 switches the plurality of cells 10 to the positive output state sequentially from cell 10 having the lowest capacitor voltage, resulting in well-balanced capacitor voltages across cells 10.

When switching cells 10 from the positive output state to the zero output state while a current is flowing in the discharge state, switching control unit 200 switches the plurality of cells 10 to the zero output state sequentially from cell 10 having the lowest capacitor voltage, resulting in well-balanced capacitor voltages across cells 10.

When switching cells 10 from the positive output state to the zero output state while a current is flowing in the charging direction, switching control unit 200 switches the plurality of cells 10 to the zero output state from cell 10 having the highest capacitor voltage, resulting in well-balanced capacitor voltages across cells 10.

When switching between the zero output state and the negative output state, cells 10 can be selected in descending or ascending order according to the magnitude of the capacitor voltages.

Next, specific description will be given with an example.

Considered here is a case where the plurality of cells 10A to 10C are connected in series in a certain phase in FIG. 1, and they alternate between “all cells being in the zero output state” and “only one cell being in the positive output state” according to the magnitude relationship between a carrier and a command value.

At this time, considering the case where the capacitor voltage of cell 10 that has entered the positive output state is discharged based on whether the command value is positive or negative and the direction of the current, description will be given of the case where cell 10A at the first stage has the highest capacitor voltage and cell 10B at the second stage has the second highest capacitor voltage.

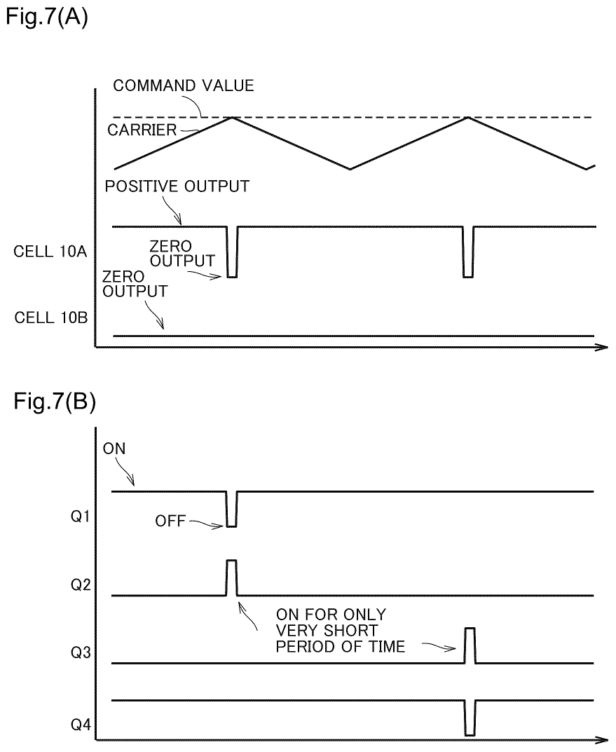

FIG. 7 is a diagram illustrating states of cells 10A and 10B according to a comparative example.

FIG. 7(A) shows the relationship between a triangular carrier and a command value.

Herein, when the period of time of “all cells being in the zero output state” is very short, cell 10A is switched to the zero output state for a very short period of time.

FIG. 7(B) is a diagram illustrating the ON/OFF states of semiconductor switch elements Q1 to Q4 according to the comparative example.

FIG. 7(B) shows the ON and OFF states of semiconductor switch elements Q1 to Q4 of cell 10A at the first stage when the state of cell 10A has changed, and semiconductor switch elements Q2 and Q3 are in the ON state for only a very short period of time.

In this regard, bipolar-type semiconductor switch elements such as insulated gate bipolar transistors (IGBTs) are switched between the ON state and the OFF state by injecting or discharging minority carriers, and if the period of time in the ON state is too short, that is, if an excessively small amount of minority carriers are injected, discharging of minority carriers is complete instantaneously at the next switching to the OFF state. This causes an electric field layer inside the semiconductor switch element to expand rapidly, and thus, a large voltage oscillation phenomenon may occur, resulting in damage to the semiconductor switch element.

Thus, a sufficient period of time is not satisfied for semiconductor switch elements Q2 and Q3 in the ON state, which may result in breakdown of semiconductor switch elements Q2 and Q3. The minimum value of the sufficient period of time that must be satisfied for the semiconductor switch in the ON state may also be referred to as a minimum ON time. The minimum ON time is determined based on, for example, the withstand voltage of the semiconductor switch element or the upper limit of the switching frequency.

In the method according to Embodiment 1, cell 10 whose state is to be switched is selected based on not only the capacitor voltage but also the state duration of each cell 10. In other words, when a predetermined period of time has not elapsed since cell 10A at the first stage entered the zero output state, switching the state of cell 10A at the first stage is prohibited. Then, from among the cells excluding cell 10A at the first stage, cell 10 whose state is to be switched is selected based on the magnitude of the capacitor voltage. Herein, the predetermined period of time is a period of time given based on the characteristics (e.g., a voltage rating, a current rating, an upper limit of a switching frequency, etc.) of the semiconductor switch elements constituting the cell, and is, for example, several microseconds to several tens of microseconds. The predetermined period of time is longer than the minimum ON time described above and may be set to any value by the designer. After the predetermined period of time has elapsed since cell 10A at the first stage entered the zero output state, cell 10A at the first stage becomes a candidate for selection again.

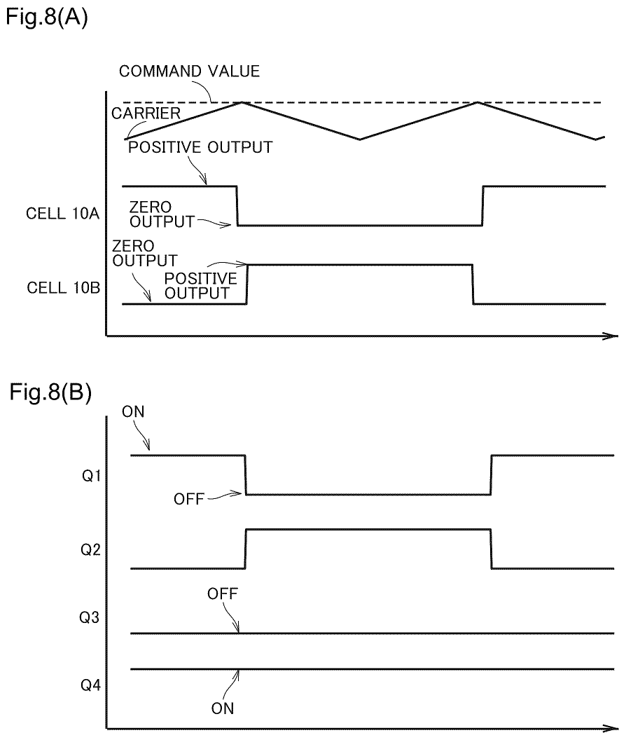

FIG. 8 is a diagram illustrating states of cells 10A and 10B according to Embodiment 1.

FIG. 8(A) shows the relationship between a triangular carrier and a command value.

Considered here is a case where the cell alternates between “all cells being in the zero output state” and “only one cell being in the positive output state”.

As described in the comparative example, cell 10A may be switched to the zero output state for a very short period of time, but if a sufficient period of time has not elapsed since cell 10A at the first stage entered the zero output state, cell 10B at the second stage, which is the second candidate, is switched to the positive output state.

Then, after a predetermined period of time has elapsed, cell 10A at the first stage becomes a candidate for selection again, and in FIG. 8, cell 10A at the first stage is switched to the positive output state again.

FIG. 8(B) is a diagram illustrating the ON/OFF states of semiconductor switch elements Q1 to Q4 according to Embodiment 1.

FIG. 8(B) shows the ON and OFF states of the semiconductor switches of the cell at the first stage, and it can be seen that a situation where the ON state lasts for only a very short period of time can be avoided.

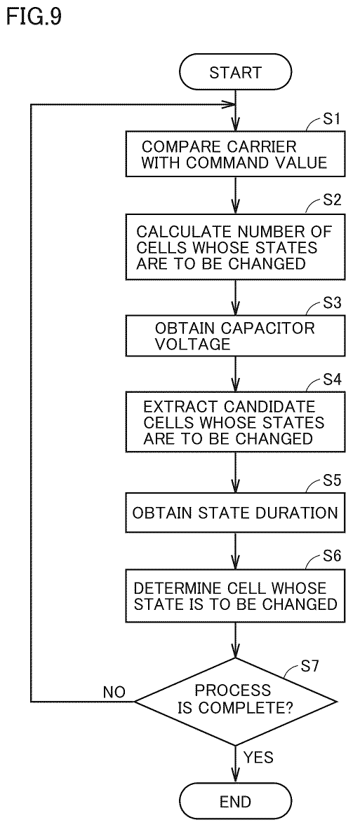

FIG. 9 is a flowchart illustrating a cell selection process by control circuit 50 according to Embodiment 1.

Referring to FIG. 9, switching control unit 200 performs processing of comparing a carrier with a command value (step S1).

Switching control unit 200 calculates the number of cells whose states are to be changed according to the comparison processing (step S2).

Subsequently, the voltage of capacitor 101 of each cell 10 is obtained (step S3). Specifically, capacitor voltage acquisition unit 201 obtains the voltage of capacitor 101 of each cell 10 and outputs the obtained voltage to switching control unit 200.

Switching control unit 200 extracts candidate cells whose states are to be changed according to the obtained voltage of capacitor 101 (step S4). Specifically, cells 10 with high capacitor voltages are extracted as candidates.

Subsequently, the duration of the state is obtained (step S5). Specifically, state duration counting unit 202 counts a period of time in which the state of each cell 10 has continued and outputs the counted period of time to switching control unit 200.

Subsequently, switching control unit 200 determines a cell whose state is to be changed (step S6). Specifically, as described above, when a predetermined period of time has elapsed since the state was switched, cell 10 with the highest priority is determined as the cell whose state is to be changed among the extracted candidate cells. In contrast, when the predetermined period of time has not elapsed since the state was switched, the cell with the second highest priority is selected as the cell whose state is to be changed. For the determined cell, the ON/OFF states of semiconductor switch elements Q1 to Q4 are controlled according to the states described with reference to FIGS. 4 and 5.

Subsequently, whether the process is complete is determined (step S7).

When it is determined in step S7 that the process is complete (YES in step S7), the process ends (END).

In contrast, when it is determined in step S7 that the process is not complete (NO in step S7), the process returns to step S1, and the above process is repeated. This process is performed at predetermined intervals.

The operation example of the present invention has been described above, but the number or states of cells are not limited. The circuit diagram of FIG. 1 shows a star-type connection diagram, but the connection may be a delta-type connection, or may be a double-star-type connection obtained by connecting two star-type connections. Further, the arm portion may include only a single cell, not a plurality of cells, and switching of the states of all the cells may be prohibited until the state duration of the cell exceeds a predetermined period of time. Additionally, a transformer may be provided in place of interconnection reactor 11.

The configuration of cell 10 in FIG. 2 has been described in terms of a full-bridge configuration, but the cell may have a half-bridge configuration with a reduced number of semiconductor switch elements, and the semiconductor switch element may not only be an IGBT but also be a conceivable element such as gate-commutated turn-off thyristor (GCT) or metal-oxide semiconductor field-effect transistor (MOSFET).

Further, a power storage battery may be provided in place of capacitor 101.

Further, regarding the level-shift PWM control in FIG. 6, the carrier is level-shifted, but the method is not limited thereto. Every figure shows an example and does not limit the configuration, components, or method.

### Embodiment 2

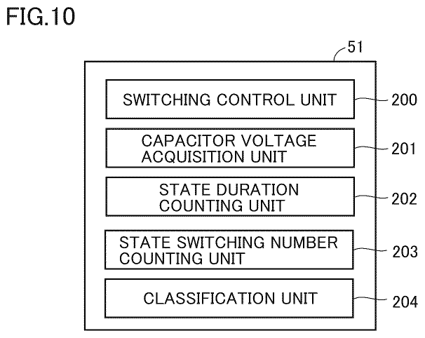

FIG. 10 is a diagram illustrating a function of a control circuit 51 according to Embodiment 2.

Referring to FIG. 10, in comparison with control circuit 50, control circuit 51 further includes a state switching number counting unit 203 and a classification unit 204 State switching number counting unit 203 counts the number of times the state of each cell 10 has been switched.

Classification unit 204 classifies a plurality of cells into a group in which the states thereof are switched preferentially based on the number of times the state has been switched, which is counted by state switching number counting unit 203.

Embodiment 2 will describe a case where characteristics of some of a plurality of cells are different.

When the characteristics of cells are different, the loss in the cells increases, causing the cells to generate heat and have higher temperature, which may shorten the life of the cells.

For example, considered here is the case where arm portion 2 corresponding to a certain phase includes a plurality of cells 10, and the capacitance of capacitor 101 of cell 10 at the first stage is smaller than that of capacitor 101 of any other cell 10.

In this case, since the capacitance of capacitor 101 of cell 10 at the first stage is smaller, even if the same current flows through capacitors 101, the capacitor voltage of cell 10 at the first stage changes more greatly than the capacitor voltage of any other cell 10. This increases the number of times cell 10 at the first stage is selected for equalization of capacitor voltages.

In other words, the number of times the semiconductor switch elements in cell 10 at the first stage are switched between the ON state and the OFF state increases. This results in an increase in switching loss.

Consequently, cell 10 at the first stage may have higher temperature, resulting in shorter life.

Cells whose states are to be switched are selected mainly in descending or ascending order of capacitor voltages of the cells, but in the method according to Embodiment 2, an increase in the number of times some cells 10 are switched is reduced.

Specifically, cell 10 whose state is to be switched is selected while taking into account not only the magnitude of the capacitor voltage but also the number of times the state of each cell 10 has been switched. In other words, the number of times the state of each cell has been switched is counted at predetermined intervals, and a lower priority is given, in selection, to a cell whose state has been switched a predetermined number of times or more.

Specific description will be given below with an example. For example, a case where there are four cells 10A to 10D in a certain phase will be described.

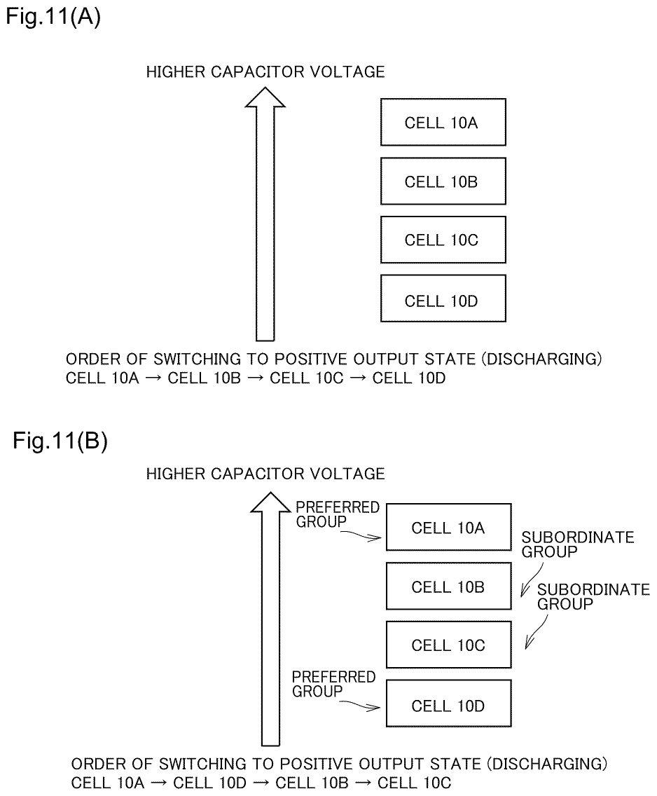

FIG. 11 is a diagram illustrating a cell switching procedure.

For example, description will be given of a case where a current is flowing such that the capacitor is discharged when the cell is switched from the zero output state to the positive output state.

Referring to FIG. 11(A), in the switching order according to the comparative example, cells are selected sequentially from cell 10A having the highest capacitor voltage and are changed to the positive output state. At this time, the number of times cell 10A has been switched is not taken into account, and cell 10 to be switched to the positive output state is determined merely based on the magnitude of the capacitor voltage. Thus, there may be a cell that is switched a relatively high number of times compared to any other cell 10.

Referring to FIG. 11(B), in the switching order according to Embodiment 2, the number of times the cell has been switched is counted for each predetermined period of time, and lower priorities are given, in selection, to cells that have been switched a relatively high number of times. In this case, description will be given of the case where a lower priority is given, in selection, to cells 10B and 10C that have been switched the number of times more than those of cells 10A and 10D.

Herein, since cells 10B and 10C are given lower priorities in selection, they will be referred to as a subordinate group, whereas cells 10A and 10D are referred to as a preferred group.

First, from the preferred group, cells 10 are selected in descending order of capacitor voltages and switched to the positive output state. Then, if there is a need for cells 10 that are to be switched to the positive output state, cells 10 are selected from the subordinate group in descending order of capacitor voltages. By so doing, cells 10B and 10C, which have been switched a relatively high number of times, are not selected preferentially regardless of the magnitude of their capacitor voltages. Thus, the switching number can be reduced.

It is effective to compare the switching number with a threshold for classification into the preferred group and the subordinate group.

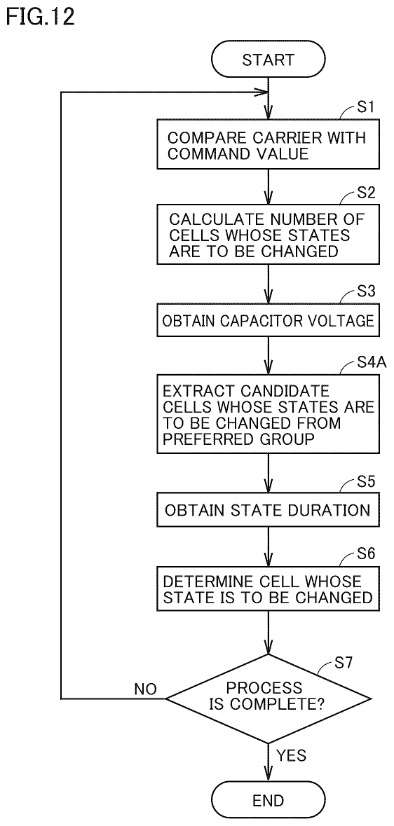

FIG. 12 is a flowchart illustrating a cell selection process by control circuit 50 according to Embodiment 2.

Referring to FIG. 12, the flowchart is different from that of FIG. 9 in that step S4 is replaced with step S4A.

Specifically, switching control unit 200 extracts candidate cells whose states are to be changed from the preferred group according to the obtained voltage of capacitor 101 (step S4A). Specifically, cells 10 with high capacitor voltages are extracted as candidates from the preferred group that has been classified in advance. If no cells can be extracted from the preferred group, cells 10 are extracted as candidates from the subordinate group.

The subsequent process is the same as that described with reference to the flowchart of FIG. 9, and thus, detailed description thereof will not be repeated.

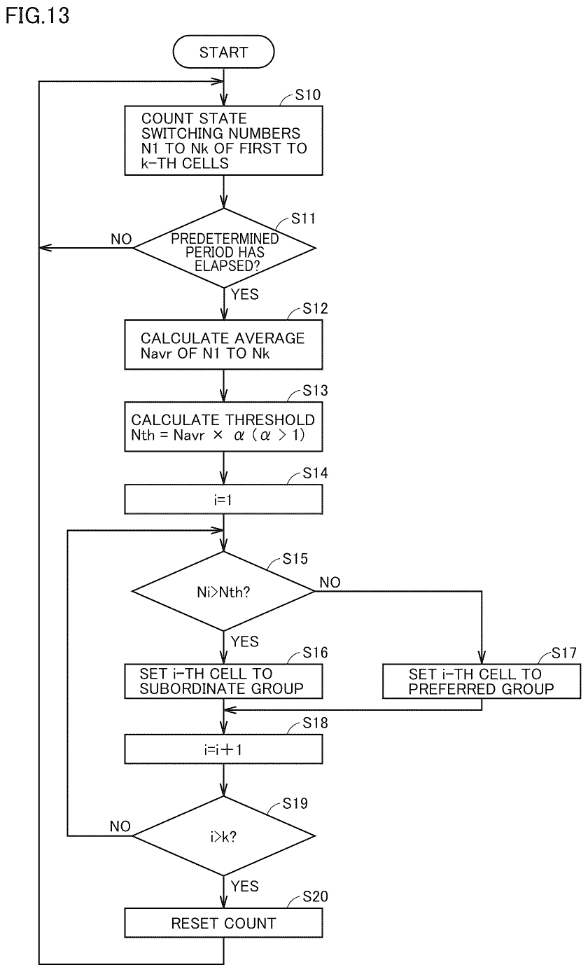

FIG. 13 is a flowchart illustrating cell classification according to Embodiment 2. Referring to FIG. 13, state switching number counting unit 203 counts state switching numbers N1 to Nk of first to k-th cells (step S10).

Subsequently, classification unit 204 determines whether a predetermined period has elapsed (step S11).

When determining in step S11 that the predetermined period has not elapsed (NO in step S11), classification unit 204 returns to step S10 and continues the counting described above.

In contrast, when determining in step S11 that the predetermined period has elapsed (YES in step S11), classification unit 204 calculates an average Navr of state switching numbers N1 to Nk (step S12). Specifically, classification unit 204 calculates average Navr of state switching numbers N1 to Nk counted by state switching number counting unit 203.

Subsequently, classification unit 204 calculates a threshold Nth (step S13). Threshold Nth is calculated by Nvar×α (α>1).

Subsequently, classification unit 204 sets an initial value i=1.

Subsequently, classification unit 204 determines whether a state switching number Ni is greater than threshold Nth (step S15).

When determining in step S15 that state switching number Ni is greater than threshold Nth, classification unit 204 sets an i-th cell to the subordinate group (step S16).

Subsequently, classification unit 204 sets i=i+1 (step S18).

In contrast, when determining in step S15 that state switching number Ni is smaller than threshold Nth, classification unit 204 sets the i-th cell to the preferred group (step S16).

Subsequently, classification unit 204 proceeds to step S18.

Subsequently, classification unit 204 determines whether a condition i>k is satisfied (step S19).

When determining in step S19 that the condition i>k is satisfied (YES in step S19), classification unit 204 then proceeds to step S20.

In step S20, classification unit 204 instructs switching number counting unit 203 to reset the count and returns to step S10.

In contrast, when determining in step S19 that the condition i>k is not satisfied (NO in step S19), classification unit 204 returns to step S15 and repeats the process described above.

Through this process, classification unit 204 sets cells having a state switching number exceeding a threshold to the subordinate group and sets cells having a state switching number below the threshold to the preferred group.

The above cells are determined according to the preferred group and the subordinate group.

The above operations are repeated at predetermined intervals.

As a result, a lower priority can be assigned to a cell, which has a relatively high switching number in a conventional method, in selection in the present disclosure, thus reducing the switching number.

### Embodiment 3

Embodiment 2 has described the order of selecting cells with the switching number taken into account, but this method may make it difficult to balance the capacitor voltages. Embodiment 3 will describe a method for classification into the preferred group and the subordinate group for further balanced capacitor voltages.

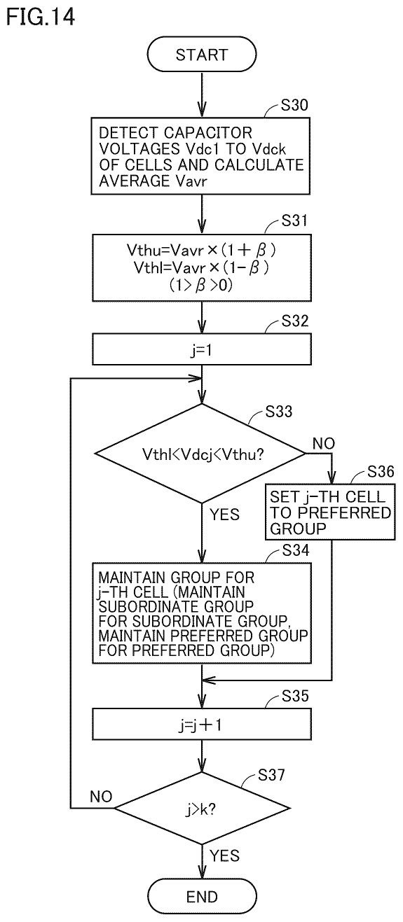

FIG. 14 is a flowchart illustrating cell classification according to Embodiment 3. Referring to FIG. 14, classification unit 204 detects capacitor voltages Vdcl to Vdck of the cells and calculates an average Vavr (step S30).

Subsequently, a first threshold Vthu (=Vavr×(1+β) and a second threshold Vthl (=Vavr×(1−β)) are calculated (step S31). (1>β>0) Subsequently, classification unit 204 sets an initial value j=1.

Subsequently, classification unit 204 determines whether a capacitor voltage Vdcj is between first threshold Vthu and second threshold Vthl (step S33).

When determining in step S33 that capacitor voltage Vdcj is between first threshold Vthu and second threshold Vthl (YES in step S33), classification unit 204 maintains the current group for the j-th cell (step S34). In other words, for the subordinate group, the subordinate group is maintained. For the preferred group, the preferred group is maintained.

Subsequently, classification unit 204 sets j=j+1 (step S35).

In contrast, when determining in step S33 that capacitor voltage Vdcj is not between first threshold Vthu and second threshold Vthl (NO in step S33), classification unit 204 sets the j-th cell to the preferred group (step S36). The process then proceeds to step S35.

Subsequently, classification unit 204 determines whether a condition j>k is satisfied (step S37).

When determining in step S37 that the condition j>k is satisfied (YES in step S37), classification unit 204 ends the process (END).

In contrast, when determining in step S37 that the condition j>k is not satisfied (NO in step S37), classification unit 204 returns to step S33 and repeats the process described above.

Through this process, classification unit 204 can reclassify cells that have been classified once according to the capacitor voltage.

Classification unit 204 performs the above process for each predetermined period of time. Specifically, the above process is repeatedly performed at the timing earlier than the initial classification.

When the capacitor voltage is within the range of Vthl to Vthu, the group to which the cell belongs is continuously maintained. In other words, cells in the preferred group are classified into the preferred group, and cells in the subordinate group are classified into the subordinate group. The above operation is repeated for each predetermined period of time.

Thus, by allowing only cells whose capacitor voltages are within the specified range to be classified into the subordinate group, the switching numbers can be equalized while balancing the capacitor voltages.

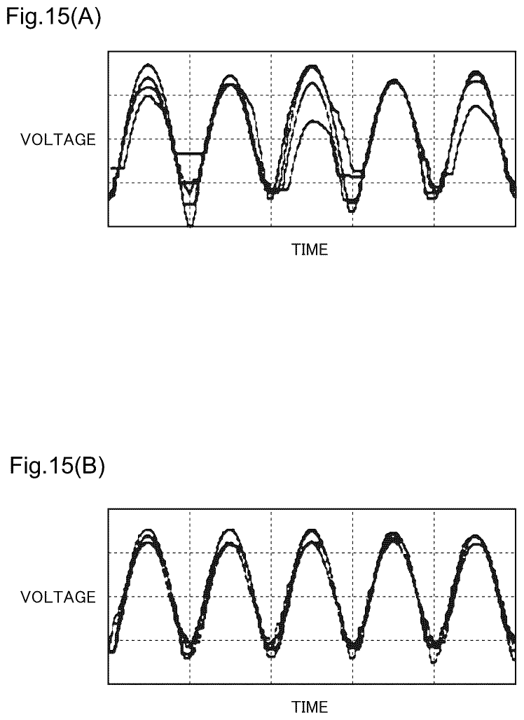

FIG. 15 is a diagram illustrating capacitor voltages of cells according to a comparative example and Embodiment 3.

Referring to FIG. 15(A), the capacitor voltages of the cells according to the comparative example exhibit variations.

In contrast, referring to FIG. 15(B), the variations in the capacitor voltages of the cells according to Embodiment 3 are reduced.

The embodiments disclosed herein should be considered to be illustrative and non-restrictive in every respect. Further, it goes without saying that there is no problem with suitably combining a plurality of embodiments, and it is desirable to further enhance the effects of the respective embodiments for efficient and economical use.

It is intended that the scope of the present disclosure is defined by claims, not only by the above description, and encompasses all modifications and variations equivalent in meaning and scope to the claims.

### REFERENCE SIGNS LIST

1 power converter; 2, 2A-2C arm portion; 3 power transmission line; 10, 10A, 10B, 10C, 10D cell; 11 interconnection reactor; 50, 51 control circuit; 101 capacitor; 104 voltage detector; 200 switching control unit; 201 capacitor voltage acquisition unit; 202 state duration counting unit; 203 state switching number counting unit; 204 classification unit.

1. A power converter comprising:
an arm portion; and
a controller to control the arm portion, wherein
the arm portion includes a plurality of cells connected in series,
each of the plurality of cells includes
a pair of connection terminals, a plurality of semiconductor switch elements,
a power storage element connected in parallel to the plurality of semiconductor switch elements, and
a voltage detector to detect a voltage of the power storage element, and
the controller
switches, in correspondence with each of the plurality of cells, states of the plurality of semiconductor switch elements included in a corresponding cell to any one of states including a state in which the pair of connection terminals of the corresponding cell output at least one voltage of a positive voltage and a negative voltage and a state in which the pair of connection terminals are conducting,
selects, for each predetermined timing, one cell of the plurality of cells, a state of the one cell being switched based on the voltage of the power storage element of each of the plurality of cells and duration of the states of the plurality of cells, and
switches the states of the plurality of semiconductor switch elements included in the selected cell, and
wherein for each predetermined timing, the controller selects one cell of the plurality of cells, a state of the one cell being switched based on the voltage of the power storage element of each of the plurality of cells, the duration of the states of the plurality of cells, and switching numbers of the states of the plurality of cells.

2. The power converter according to claim 1, wherein the controller prohibits switching of the selected cell to the other state until a predetermined period of time has elapsed since switching of the state of the selected cell.

3. (canceled)

4. The power converter according to claim wherein the controller
counts, for each cell, a number of times the state has been switched for each predetermined interval,
classifies, into a first cell group, a cell of the plurality of cells that has been switched a number of times equal to or less than a predetermined value and classifies, into a second cell group, a cell of the plurality of cells that has been switched a number of times exceeding the predetermined value, and
preferentially selects a cell from the first cell group, a state of the cell being switched for each predetermined timing.

5. The power converter according to claim 4, wherein the controller classifies a cell of the plurality of cells into the second cell group, a state of the cell having been switched a number of times exceeding the predetermined value, a voltage of the power storage cell of the cell being in a predetermined range.

6. A method of controlling a power converter including an arm portion,
the arm portion including a plurality of cells connected in series, each of the plurality of cells including
a pair of connection terminals,
a plurality of semiconductor switch elements,
a power storage element connected in parallel to the plurality of semiconductor switch elements, and
a voltage detector to detect a voltage of the power storage element, the method comprising:
selecting one cell of the plurality of cells for each predetermined timing, a state of the one cell being switched based on the voltage of the power storage element of each of the plurality of cells and duration of states of the plurality of cells;
switching the states of the plurality of semiconductor switch elements included in the selected cell to any one of states including a state in which the pair of connection terminals of the selected cell output at least one voltage of a positive voltage and a negative voltage and a state in which the pair of connection terminals are conducting; and
for each predetermined timing, selecting one cell of the plurality of cells, a state of the one cell being switched based on the voltage of the power storage element of each of the plurality of cells, the duration of the states of the plurality of cells, and switching numbers of the states of the plurality of cells.-
